(19) United States
(12) Patent Application Publication
(10) Pub. No.: US 2016/0267612 A1
(43) Pub. Date: Sep. 15, 2016

(54) CENTRALLY MANAGED LICENSING IN A GLOBAL VPN INFRASTRUCTURE

(71) Applicant: SonicWALL, Inc., San Jose, CA (US)

(72) Inventors: Karl Stefan Dyszynski, Lynnwood, WA (US); Christopher D. Peterson, Bellingham, WA (US)

(21) Appl. No.: 14/657,904

(22) Filed: Mar. 13, 2015

(51) Int. Cl. G06Q 50/18; H04L 12/24

(52) U.S. Cl. CPC G06Q 50/184; H04L 41/044; H04L 41/12; G06Q 2220/18

(57) ABSTRACT

The present system provides centrally managed licensing where licensed user capacity may flow to where it is most needed. All user capacity may be allocated to the appliances. This provides a much better experience if communication between the central license server is severed from an appliance, as the appliance can still continue to service connections up to that allocated capacity even though it is unable to contact the central license manager. Sublicenses are created from a master license and allocated to appliances. The appliances may provide services based on the licensed set of features and user capacity allocated to them without any further communication with a central server that provided the sub-licenses. The central server may collect information from each appliance and may re-allocate licensed user capacity among the appliances.

### BACKGROUND

In a globally distributed environment, issuing and maintaining a license such as a virtual private network (VPN) license can be challenging. For example, when managed by a central license manager, the connection between an appliance and the central license manager can be severed at any time. A VPN environment is particularly susceptible to this issue because often the VPN provides the most value during times of crisis when connectivity to a network is desired the most—the same time when connectivity to a portion of the worldwide network may be lost.

A licensing system that has a single point of failure is not well suited to serve clients that depend on a global VPN infrastructure for localized access.

What is needed is a more reliable licensing system for serving clients that depend on a global VPN infrastructure for localized access.

### SUMMARY

The present system provides centrally managed licensing where a central license allows user capacity to be allocated to where it is most needed. All user capacity may be allocated to the appliances. This provides a much better experience if communication between the central license server is severed from an appliance, as the appliance can still continue to service connections up to that allocated capacity even though it is unable to contact the central license manager.

Leased licenses are created from a master license and allocated to appliances. The appliances may service users up to the capacity associated with the leased license without any further communication with a central server that provided the leased licenses. The central server specifies a minimum and maximum lease license user capacity for each appliance based on each appliance's hardware capability and administrator preference. The central server may collect the user count being serviced by each appliance on a regular cadence and may re-allocate capacity among all appliances based on appliance user counts, minimum and maximum user capacity settings, and the user capacity of the master license.

In an embodiment, a method for centrally managing licenses to multiple devices may begin with accessing a license associated with a capacity to be distributed to a plurality of appliances. An allocation of capacity may be determined by a server for a plurality of appliances. An indication of the capacity may be provided to each of the plurality of appliances by the server. Usage information may be received by the server from one or more of the appliances, the usage information including a count of one or more users serviced by a particular appliance of the one or more appliances without additional communication from the server.

A system for tracing a distributed transaction may include a server and appliances. One or more modules stored on server memory may be executable by a server processor to access a license associated with a capacity to be distributed to a plurality of appliances, determine an allocation of capacity by a server for a plurality of appliances, provide an indication of the capacity to each of the plurality of appliances by the server; and receive usage information by the server from one or more of the appliances, the usage information including a count of one or more users serviced by a particular appliance of the one or more appliances without additional communication from the server.

### BRIEF DESCRIPTION OF THE DRAWINGS

FIG. 1 is a block diagram for providing a centrally managed licensing system.

FIG. 2 is a block diagram of a central management server.

FIG. 3 is a block diagram of an appliance.

FIG. 4 is a method for centrally managing VPN licenses.

FIG. 5 is a method for managing licenses by an appliance.

FIGS. 6A-B are a method for allocating licenses to appliances.

FIG. 7 is a block diagram of an exemplary computing system for implementing the present technology.

### DETAILED DESCRIPTION

The present system provides centrally managed licensing where a central license allows user capacity to be allocated to where it is most needed. All user capacity may be allocated to the appliances. This provides a much better experience if communication between the central license server is severed from an appliance, as the appliance can still continue to service connections up to that allocated capacity even though it is unable to contact the central license manager.

Leased licenses are created from a master license and allocated to appliances. This leased license contains the same set of licensed features as the master license, only a portion of the user capacity available in the master license that should be provided by each appliance. These leased licenses may have an effective duration that is less than the duration of the master license. The appliances may service users up to the capacity associated with the leased license and provide the features contained within the leased license without any further communication with a central server that provided the leased licenses. The central server specifies a minimum and maximum user capacity for each appliance based on hardware capability and administrator preferences. The central server may collect the user count being serviced by each appliance on a regular cadence and may re-allocate capacity among all appliances based on appliance user counts, minimum and maximum user capacity settings, and the user capacity of the master license.

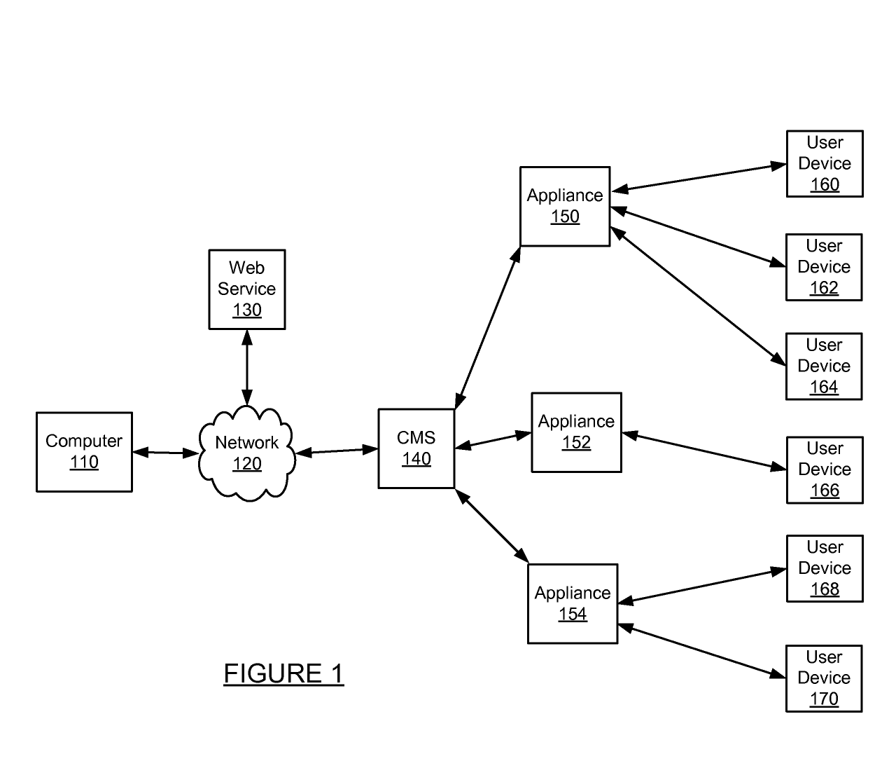

FIG. 1 is a block diagram for providing a centrally managed licensing system. The system of FIG. 1 includes computer 110, network 120, web service 130, central management server 140, and appliances 150, 152, and 154. Computer 110 may communicate with web service 130 via network 120. Computer 110 may include any device that may communicate over a network.

The network may be implemented as one or more networks capable of transmitting digital or analog information, such as the Internet, a Wi-Fi network, a public or private network, or some other digital or analog communication network.

Web service 130 may include one or more web servers, application servers, data stores, and other machines or services to provide one or more interfaces, such as a web page interface, for allowing a user to purchase a master license. A master license may be obtained through an interface provided by web service 130, downloaded to computer 110, and then uploaded to CMS 140. CMS 140 can then be accessed to configure settings for the license and/or appliances 150, 152 and 154 from computer 110.

The master license may provide a capacity of users that can be serviced by appliances as well as a number of sub-feature capabilities, such as spike licenses that may be used in times of spike usage.

Web service 130 may communicate with computer 110, central management server 140, and optionally other devices. The licenses may be for a virtual private network (VPN) service provided by the appliances.

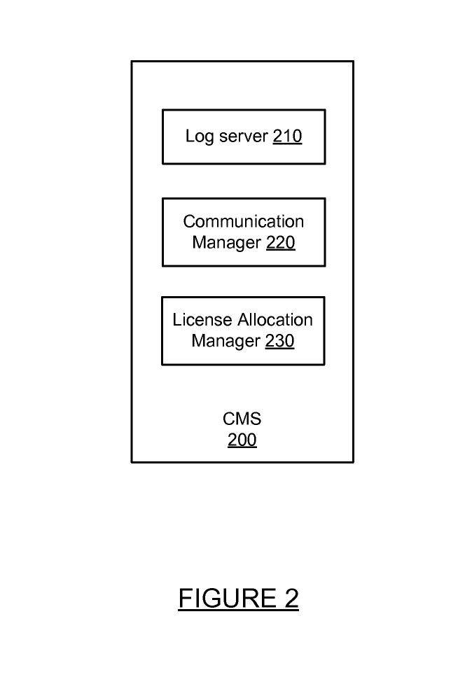

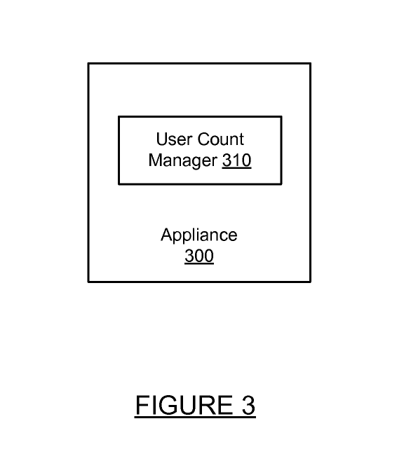

Central management server (CMS) 140 may communicate with computer 110, web service 130, appliances 150-154, and other devices. A master license may be installed on CMS 140, for example based on a purchase through web service 130. The CMS is then able to create new leased licenses (sub licenses) up to the capacity of the master license to then distribute to the various appliances (150, 152, and 154). CMS 140 is discussed in more detail with respect to the block diagram of FIG. 2.

Appliances 150, 152 and 154 use their individual leased licenses to authorize them to provide a set of services to users. The number of users that they may service as well as the features those appliances may provide are determined by the leased licenses received from the CMS.

Appliances 150-154 may each receive a unique leased license from CMS 140. Appliance 150 may service users up to a capacity specified in its particular leased license. The leased license applied or allocated to an appliance may be used by the appliance without further communication from CMS 140. As a result, appliance 150 may service users without communication from CMS 140, and there is no disruption of the VPN service if communication between an appliance and CMS 140 is severed. This is advantageous in a situation where communication with the CMS becomes unavailable. Appliance 150 is discussed in more detail below with respect to the block diagram of FIG. 3. Appliances 152 and 154 may operate in the same way as appliance 150.

User device 160 may receive VPN service from appliance 150. From the point of view of the user device 160, the entire transaction to obtain the VPN service is through appliance 150. There is no communication between user device 160 and CMS 140. Additionally, appliance 150 does not need to communicate with central managed server 140 in order to provide service to user device 160. User devices 162, 164, 166, 168, and 170 may also communicate with appliances 150, 152, 154, in order to obtain VPN service managed by a particular appliance as long as the count of users serviced by the appliance has not exceeded the count specified in the leased license for the particular appliance.

FIG. 2 is a block diagram of a CMS. The CMS 200 of FIG. 2 provides more detail of appliance 150 of the system of FIG. 1. CMS 200 includes log server 210, communication manager 220, and license allocation manager 230. Log server 210 may log information sent to and received by a one or more appliances. In particular, the log server may handle logging and monitoring of leased license allocation by the CMS. Communication manager 220 may handle communications to and from each of appliances 150, 152, 154. The communications may include providing a new leased license to an appliance as well as receiving updates and other communications from the appliances regarding the number of active users on the appliance. License allocation manager 230 may calculate how much user capacity is needed for each managed appliance. License allocation is discussed in more detail below.

FIG. 3 is a block diagram of an appliance. Appliance 300 may provide more detail for an appliance illustrated in the block diagram of FIG. 1. Appliance 300 may include a user count manager 310. The user count manager may receive a new leased license and install it on the appliance to change the number of users this appliance is licensed to service. Appliance 300 may service user connections up to the limits imposed by that leased license and provide the services enabled by the leased license without further communication from the central license distribution point, CMS (140).

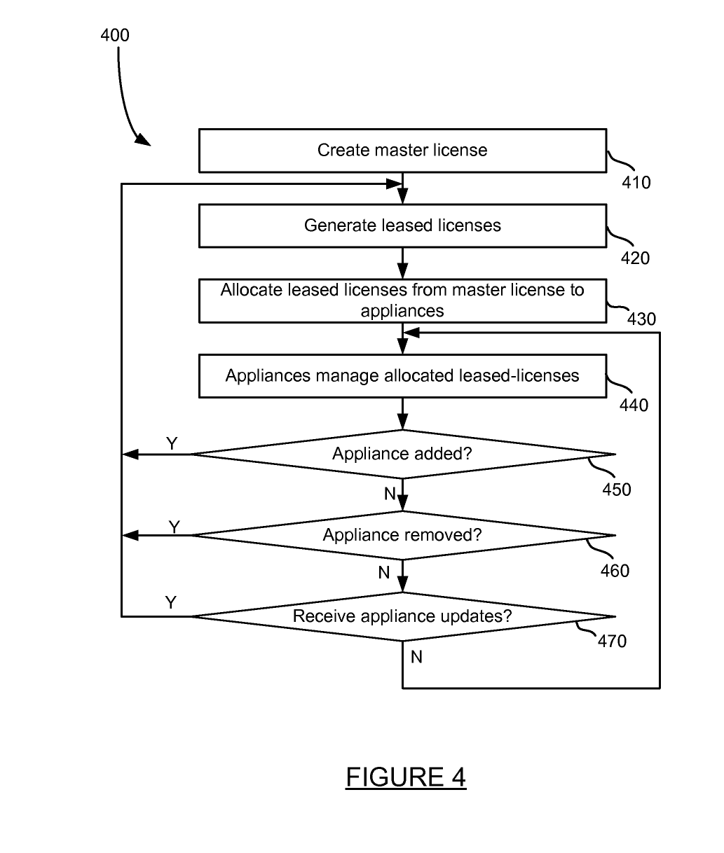

FIG. 4 is a method for centrally managing VPN licenses. First, a master license is created at step 410. The master license may be created in response to receiving a request for a license through a web service or other service accessible to administrators wishing to obtain a license. The master license may be purchased and downloaded from Web Service 130 and then uploaded to the CMS.

Leased licenses are generated at step 420. The leased licenses may be generated based on the capacity allowed by the master license, the set of managed appliances that will need a leased license, the user counts on each of those managed appliances, the set of features enabled in the master license, the duration of the master license, and the minimum and maximum lease license capacities that the CMS specifies for each appliance.

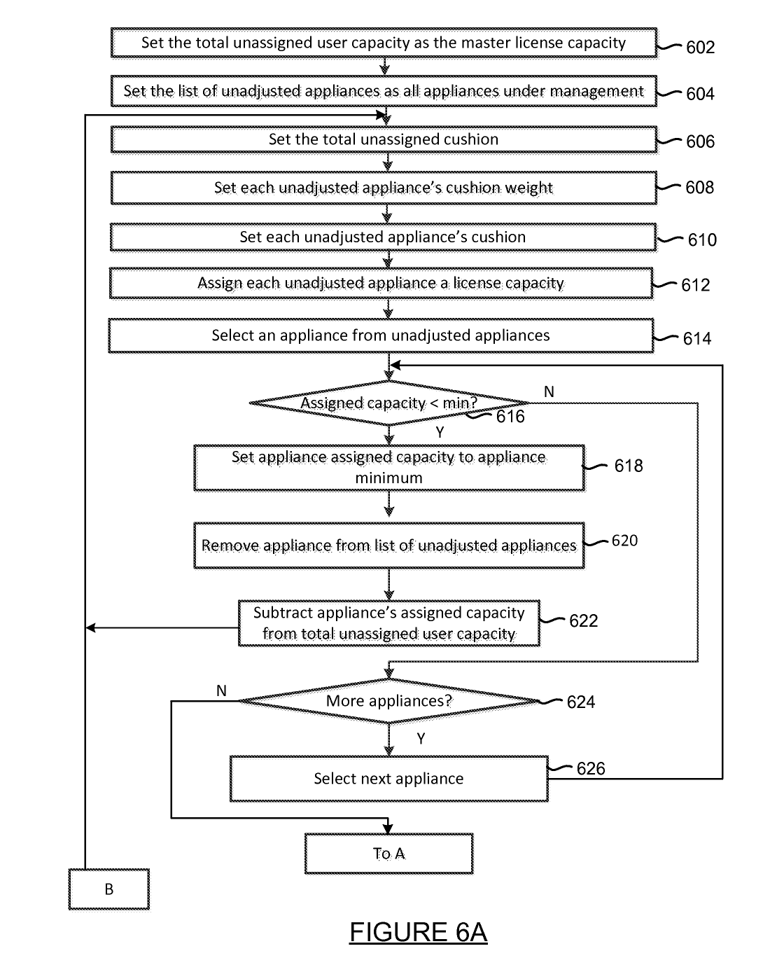

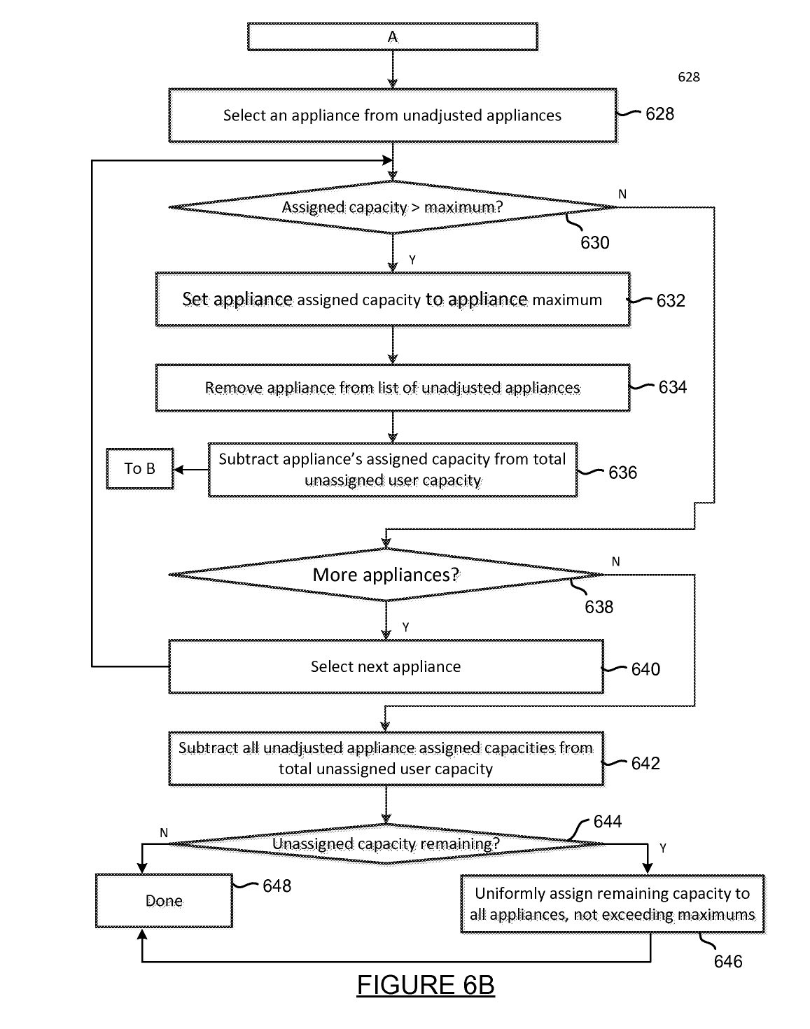

Leased licenses are distributed to one or more appliances at step 430. The leased licenses may be distributed to the appliances to provide a predetermined level of cushion or margin of licenses to distribute. One leased license is provided for each appliance, and the total capacity provided to all appliances should add up to the count provided by the master license. In some instances the leased licenses are created with unequal (weighted) cushions of extra licenses where larger cushions go to appliances with higher maximum license size settings. More detail for allocating leased licenses from a master license to appliance discussed with respect to the method of FIG. 6.

An appliance may manage the leased license distributed to it at step 440. Managing the leased license may include servicing users that request VPN service up until the appliance capacity has been reached. An appliance may service a user without communication with the CMS.

In some instances, a leased license may expire after a period of time. For example, the term of a leased license may be a day, several days, a week, or some other period of time. In these cases the CMS will automatically distribute a new leased license to the managed appliances before the duration of the leased license expires, provided that the managed appliance is in communication with the CMS. This prevents licenses from lasting forever if communication to the CMS is permanently lost by an appliance. In some instances, the CMS may not mint or create a leased license that will outlive the master license.

As appliances are managing their leased license, a determination may be made by the CMS as to whether a new appliance is added to the group of appliances at step 450. If an appliance has been added, the method of FIG. 4 continues to step 420 where the leased license for all appliances are re-generated. If an appliance has not been added, a determination is made as to whether CMS detects that an appliance has been removed from the group of appliances at step 460. If an appliance has been removed, the method continues to step 420 where the leased licenses for all the appliances are re-generated.

If no appliance is detected to be added or removed, a determination is made as to whether any appliance updates have been received by CMS 140 at step 470. In some instances, each appliance will provide an update to the CMS. The update may include the number of users consuming license with the particular appliance. The updates may be provided every 30 seconds, 1 minute, 5 minutes, 10 minutes, or some other period of time. If appliance updates have been received at step 470, the CMS may re-generate the leased licenses at step 420 and continue to step 430.

In some instances, a CMS will not reallocate leased licenses among appliances as soon as an appliance is added or removed. Rather, the CMS may determine if, over a period of time such as 30 seconds or some other period of time, an appliance was added or removed, and whether any appliance updates are received. This may improve the efficiency of the CMS as well as provide for more efficient communication between the CMS and the appliances.

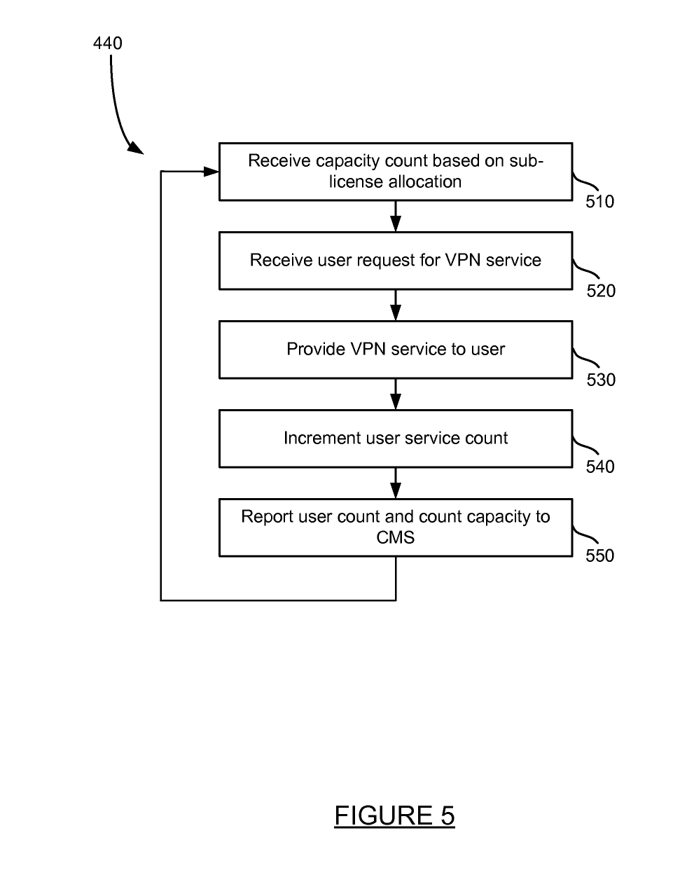

FIG. 5 is a method for managing licenses by an appliance. First, an appliance receives a leased license that contains within it a specific user capacity and a set of licensed functionality that this appliance may provide at step 510. Once an appliance has a leased license which contains a count for user capacity, and a set of licensed services the managed appliance may receive and process a VPN request for those services at step 520. Once the request is received, the service may be provided to the user at step 530. In some instances, a user request may only be serviced if providing the service would not exceed the user capacity received at step 510, and the service is one of the features enabled by the leased license. Once the user is serviced, the user count may be incremented at step 540. In some instances, when service associated with a leased license expires or terminates, the user capacity may be decreased (not shown in FIG. 5). The appliance may continuously update the user count to the CMS as users are provided and stop consuming VPN services.

An appliance may report the user count to CMS 140 at step 550. The count may include the number of users that currently are serviced by the particular appliance. The report of the user count may be provided to the CMS periodically, in response to user consuming VPN services, or based on some other event. The method of FIG. 5 then returns to step 510.

FIG. 6 is a method for allocating licenses to appliances. The method of FIG. 6 provides more detail for steps 420 of the method of FIG. 4. The method involves assigning license capacities to each appliance, evaluating whether the capacities satisfy minimum and maximum capacity constraints, and adjusting the assigned capacities until the constraints are satisfied. Assigning a license capacity may not be the same as distributing a license. An assigned license capacity for a given appliance may change over the course of one iteration of this method. Only after this method has finished execution are leased licenses created and distributed.

The total unassigned user capacity (user capacity that this method has not yet assigned to an appliance) is set to the master license capacity at step 602. The list of unadjusted appliances (appliances that this method has not definitively assigned a license capacity) is set to all appliances under management at step 604. The total unassigned cushion is determined as equal to the total unassigned capacity minus the total users currently serviced by unadjusted appliances at step 606.

A cushion weight is determined for a given unadjusted appliance by the maximum license capacity for that appliance divided by the maximum license capacity for all unadjusted appliances at step 608. The cushion is then determined for a given appliance by multiplying the cushion weight for that appliance by the total unassigned cushion at step 610. The cushions are thus weighted based on the maximum license capacity settings for each appliance. For example, an appliance with a maximum license capacity of 10,000 users will have twice the cushion of an appliance with a maximum license capacity of 5,000 users.

The license capacity for a given appliance is set to the current user count of that appliance plus the cushion calculated for that appliance at step 612. For example, if the cushion for an appliance is calculated to be 1,500 users and the appliance is currently servicing 673 users then that appliance will be assigned a license capacity of 2,173 users (initially).

A determination is made for each unadjusted appliance as to whether the assigned lease license capacity is less than the minimum license capacity allowed at step 616. An appliance may not be allocated a license with a capacity that is less than the minimum license capacity designated for that appliance. If an assigned license capacity is greater than or equal to the respective minimum capacities, the method continues to step 624. If any assigned license capacity is less than the minimum, the assigned license capacity for that appliance is set to the minimum license capacity allowed for that appliance at step 618. Additionally, the appliance is removed from the list of unadjusted appliances at step 620 (the appliance is definitively adjusted), the appliance's assigned license capacity is subtracted from the total unassigned capacity at step 622, and the method continues to step 606 and recalculates the assigned license capacities for all remaining unadjusted appliances.

A determination is made as to whether there are any additional appliances to check for assigned capacity in view of the minimum capacity at step 624. If more appliances exist to be checked, the next appliance is checked at step 626 and the method returns to step 616. If no additional appliances exist to be checked, the method continues to step 628 of FIG. 6B.

In FIG. 6B, an appliance is selected at step 628 and a determination is made for the unadjusted appliance as to whether the assigned lease license capacity is greater than the maximum license capacity allowed at step 630. An appliance may not be allocated a license with a capacity that is greater than the maximum license capacity designated for that appliance. If the selected appliance's assigned capacity is not greater than the maximum, a determination is made as to whether there are any additional appliances to check for assigned capacity in view of the maximum capacity at step 638. If more appliances exist to be checked, the next appliance is checked at step 640 and the method returns to step 630. If no additional appliances exist to be checked, the method continues to step 642. As such, if all assigned license capacities are less than or equal to the respective maximum capacities, the method continues to step 642.

If at step 630 any assigned license capacity is greater than the maximum, the assigned license capacity for that appliance is set to the maximum license capacity allowed for that appliance at step 632. Additionally, the appliance is removed from the list of unadjusted appliances at step 634 (the appliance is definitively adjusted), the appliance's assigned license capacity is subtracted from the total unassigned capacity at step 636, and the method returns to step 606 of FIG. 6A to recalculate the assigned license capacities for all remaining unadjusted appliances.

At step 642, all assigned license capacities for unadjusted appliances satisfy the minimum and maximum constraints. All assigned license capacities for unadjusted appliances are subtracted from the total unassigned capacity at step 642 and the list of unadjusted appliances is emptied. There are no remaining unadjusted appliances; all appliances under management have been assigned a new license capacity with an appropriate value that satisfies minimum and maximum constraints.

A determination is made at step 644 as to whether some unassigned capacity still exists, for example due to division rounding errors. If some capacity still exists, all appliance capacities are uniformly incremented at step 646 until no unassigned capacity remains, making sure not to exceed any appliance maximum capacity settings. When the unassigned capacity is zero, there are no licenses left to assign from the master license and the method of FIG. 6 is complete at step 648.

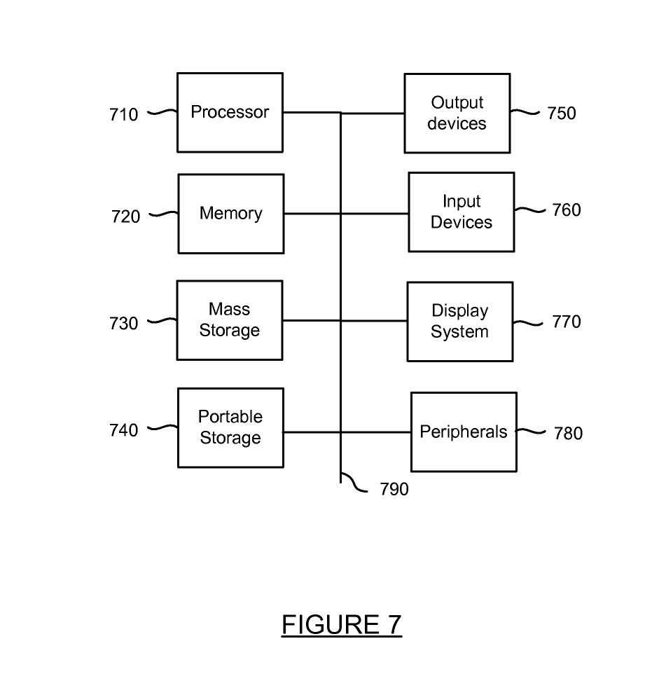

FIG. 7 is a block diagram of an exemplary computing system for implementing the present technology. System 700 of FIG. 7 may be implemented in the contexts of the likes of client computer 110, web servers, application servers and other machines that may be used to provide web service 130, CMS 140, appliances 150, 152 and 154, and user devices 160-170. The computing system 700 of FIG. 7 includes one or more processors 710 and memory 720. Main memory 720 stores, in part, instructions and data for execution by processor 710. Main memory 720 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. However, the components may be connected through one or more data transport means. For example, processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 720.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Examples of suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. For example, peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, smart phone, mobile computing device, workstation, server, minicomputer, mainframe computer, or any other computing device. As such, the computer system 700 of FIG. 7 may include additional components, such as an LED touch screen, one or more antennas, radios, and other circuitry and software for wireless communication, microphones, speakers, and other components. The computer can also include different bus configurations, networked platforms, multi-processor platforms, etc. Various operating systems can be used including Unix, Linux, Windows, Macintosh OS, Android, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for centrally managing licenses to multiple devices, comprising:
accessing a license associated with a capacity to be distributed to a plurality of appliances;
determining an allocation of capacity by a server for a plurality of appliances;
providing an indication of the capacity to each of the plurality of appliances by the server; and
receiving usage information by the server from one or more of the appliances, the usage information including a count of one or more users serviced by a particular appliance of the one or more appliances without additional communication from the server.

2. The method of claim 1, further comprising re-allocating the capacity to the plurality of appliances based on the usage information received from the one or more of the plurality of appliances.

3. The method of claim 2, wherein the re-allocation of capacity is determined based on user information received from all of the plurality of appliances.

4. The method of claim 1, further comprising:
detecting an appliance has been added or removed to the plurality of appliances; and
reallocating the capacity to the plurality of appliances.

5. The method of claim 1, further comprising generating a license at a server, wherein the capacity is allocated based on the master license.

6. The method of claim 1, wherein determining an allocation includes determining a weighted cushion of unused capacity for each of the plurality of appliances.

7. The method of claim 6, wherein the weighted cushion is based on individual capacity of an appliance and a maximum capacity of all the appliances.

8. The method of claim 1, wherein the capacity is for providing a virtual private network service.

9. The method of claim 1, wherein the capacity is configured to expire within a set period of time if there is no communication between the particular appliance and the server.

10. The method of claim 1, wherein the set of features enabled in each leased license is automatically determined by the capabilities of the master license installed on the server.

11. A non-transitory computer readable storage medium having embodied thereon a program, the program being executable by a processor to perform a method for centrally managing licenses to multiple devices, the method comprising:
accessing a license associated with a capacity to be distributed to a plurality of appliances;
determining an allocation of capacity by a server for a plurality of appliances;
providing an indication of the capacity to each of the plurality of appliances by the server; and
receiving usage information by the server from one or more of the appliances, the usage information including a count of one or more users serviced by a particular appliance of the one or more appliances without additional communication from the server.

12. The non-transitory computer readable storage medium of claim 11, the method further comprising further comprising re-allocating the capacity to the plurality of appliances based on the usage information received from the one or more of the plurality of appliances.

13. The non-transitory computer readable storage medium of claim 12, wherein the re-allocation of capacity is determined based on user information received from all of the plurality of appliances

14. The non-transitory computer readable storage medium of claim 11, the method further comprising:
detecting an appliance has been added or removed to the plurality of appliances; and
reallocating the capacity to the plurality of appliances.

15. The non-transitory computer readable storage medium of claim 11, the method further comprising generating a master license at a server, wherein the capacity is created from the master license.

16. The non-transitory computer readable storage medium of claim 11, wherein determining an allocation includes determining a weighted cushion of unused capacity for each of the plurality of appliances.

17. The non-transitory computer readable storage medium of claim 16, wherein the weighted cushion is based on individual capacity of an appliance and maximum capacity of all the appliances.

18. The non-transitory computer readable storage medium of claim 11, wherein the capacity is for providing a virtual private network service.

19. The non-transitory computer readable storage medium of claim 11, wherein the capacity is configured to expire within a set period of time if there is no communication between the particular appliance and the server.

20. The non-transitory computer readable storage medium of claim 11, wherein the set of features enabled in each leased license is automatically determined by the capabilities of the master license installed on the server.
